(19) United States
(12) Patent Application Publication
(10) Pub. No.: US 2019/0010023 A1
(43) Pub. Date: Jan. 10, 2019

(54) ELEVATOR SYSTEM RUNBY MONITORING AND ADJUSTMENT

(71) Applicant: Otis Elevator Company, Farmington, CT (US)

(72) Inventors: Aurelien Fauconnet, Isdes (FR); Frederic Beauchaud, Coullons (FR); Bi Xiong, Gien (FR)

(21) Appl. No.: 16/066,870

(22) PCT Filed: Dec. 28, 2015
(86) PCT No.: PCT/IB2015/002569

§ 371 Date: Jun. 28, 2018

(51) Int. Cl. B66B 5/00; B66B 9/00; B66B 3/00; B66B 1/34

(52) U.S. Cl. CPC B66B 5/0025; B66B 9/00; B66B 5/0087; B66B 5/0037; B66B 1/3492; B66B 5/0031; B66B 5/0056; B66B 3/002

(57) ABSTRACT

A runby monitoring system for an elevator system includes a sensor fixed in a hoistway of the elevator system, and a sensed element located at a moving component of the elevator system. The sensor is configured to detect a presence of the sensed element when the sensed element is substantially aligned with the sensor in the hoistway. The detection of the presence of the sensed element at an expected elevator system operational point is indicative of a clearance between the moving component of the elevator system and a lowermost extent of the hoistway within a preselected range.

### BACKGROUND

The subject matter disclosed herein relates to elevator systems. More particularly, the present disclosure relates to monitoring and adjustment of elevator system runby.

“Runby” is a term used in the art of elevator systems to describe a clearance between a bottom of a counterweight of the elevator system and a bottom, or pit floor, of the elevator system hoistway. In some cases, buffers are fixed to the bottom of a counterweight frame, and the runby is a clearance between the buffers and the pit floor. Alternatively, the buffers are fixed in the pit, with the runby then being a clearance between the buffers and a bottom of the counterweight frame. Still alternatively, the runby may be clearance between an elevator car of the elevator system and the pit floor. In a typical elevator system, the runby is set during installation of the elevator system and then checked periodically, for example, yearly, by maintenance personnel. The runby measurement may vary over time due to rope or belt elongation over time and/or building settling. If the runby measurement falls outside of a preselected range of values, the maintenance personnel may then adjust the runby so that it again is within the preselected range.

The measurement and subsequent adjustment of runby is presently a time consuming and labor intensive process. First, the elevator car is moved to its uppermost position in the hoistway, so the counterweight is at its lowest. The service personnel then enter the pit at the bottom of the hoistway and measures the runby. If the measured runby is outside of a preselected range of values and adjustment is needed, the service personnel must ride the elevator car to the top of the hoistway, climb to the top of the elevator car, and adjust the runby and the rope or belt termination at the top of the hoistway.

When service personnel are required to enter the pit to check and adjust the runby, or perform other maintenance activities, a safety volume must be provided in the hoistway to protect the service personnel. The safety volume occupies a large amount of hoistway space. Elevator system customers, however, desire that the elevator system occupy a smaller overall volume. Thus, new elevator systems are being developed in which many maintenance activities can be performed from inside the car, alleviating the need to provide such a safety volume in the pit and/or at a top of the hoistway.

### SUMMARY

In one embodiment, a runby monitoring system for an elevator system includes a sensor fixed in a hoistway of the elevator system, and a sensed element located at a moving component of the elevator system. The sensor is configured to detect a presence of the sensed element when the sensed element is substantially aligned with the sensor in the hoistway. The detection of the presence of the sensed element at an expected elevator system operational point is indicative of a clearance between the moving component of the elevator system and a lowermost extent of the hoistway within a preselected range.

Additionally or alternatively, in this or other embodiments lack of detection of the presence of the sensed element at the expected elevator system operational point is indicative of the clearance outside of the preselected range.

Additionally or alternatively, in this or other embodiments an elevator control system is operably connected to the sensor to continuously monitor the detection of the sensed element by the sensor.

Additionally or alternatively, in this or other embodiments a remote elevator monitoring system initiates a maintenance action in the case of a lack of detection of the presence of the sensed element at the expected elevator system operational point.

Additionally or alternatively, in this or other embodiments the sensor is a magnetic switch affixed at the hoistway and the sensed element is a magnet affixed to the moving component.

Additionally or alternatively, in this or other embodiments the moving component is an elevator system counterweight.

In another embodiment, an elevator system includes a hoistway, an elevator car drivable along the hoistway, a suspension member disposed in the hoistway and operably connected to the elevator car to suspend and/or drive the elevator car along the hoistway, a counterweight operably connected to the suspension member to balance operation of the elevator system, and a runby monitoring system. The runby monitoring system includes a sensor fixed in the hoistway, and a sensed element located at a moving component of the elevator system. The sensor is configured to detect a presence of the sensed element when the sensed element is substantially aligned with the sensor in the hoistway. The detection of the presence of the sensed element at an expected elevator system operational point is indicative of a clearance between the moving component and a lowermost extent of the hoistway within a preselected range.

Additionally or alternatively, in this or other embodiments lack of detection of the presence of the sensed element at the expected elevator system operational point is indicative of the clearance outside of the preselected range.

Additionally or alternatively, in this or other embodiments an elevator control system is operably connected to the sensor to continuously monitor the detection of the sensed element by the sensor.

Additionally or alternatively, in this or other embodiments an elevator car service panel is positioned at the elevator car to allow for adjustment of the clearance without exiting the elevator car.

Additionally or alternatively, in this or other embodiments an indicator is positioned at the elevator car service panel operably connected to the sensor to provide indication of detection and/or lack of detection of the sensed element by the sensor.

Additionally or alternatively, in this or other embodiments the elevator car is disposed at an uppermost position in the hoistway at the expected elevator system operational point.

Additionally or alternatively, in this or other embodiments the moving component is the counterweight.

In yet another embodiment, a method of operating an elevator system includes driving an elevator car to an uppermost extent of a hoistway and checking for the presence of a moving component of the elevator system at an expected hoistway location via a sensor fixed at the hoistway and a sensed element secured to the moving component. The sensor is configured to detect a presence of the sensed element when the sensed element is substantially aligned with the sensor in the hoistway. The detection of the presence of the sensed element is indicative of a clearance between the moving component and a lowermost extent of the hoistway within a preselected range.

Additionally or alternatively, in this or other embodiments the clearance between the moving component and the lowermost extent of the hoistway is adjusted if the presence of the sensed element is not detected by the sensor.

Additionally or alternatively, in this or other embodiments the clearance is adjusted by accessing a runby adjusting mechanism through an elevator car service panel of the elevator car and operating the runby adjusting mechanism until the sensor detects the presence of the sense element.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic view of an embodiment of an elevator system;

FIG. 2 is a schematic view of an embodiment of a runby monitoring system for an elevator system; and

FIG. 3 is another schematic view of an embodiment of a runby detection system for an elevator system.

### DETAILED DESCRIPTION

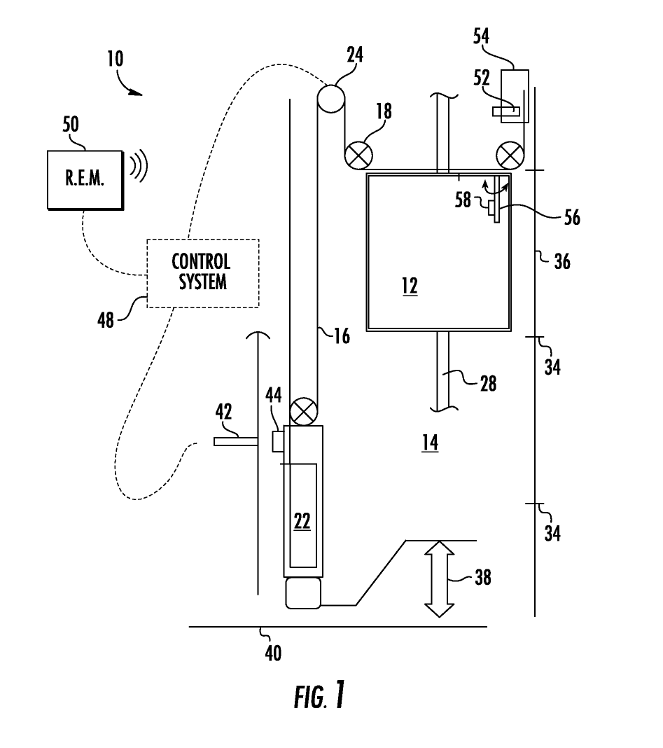

Shown in FIG. 1 is a schematic of an exemplary traction elevator system 10. The elevator system 10 includes an elevator car 12 operatively suspended or supported in a hoistway 14 with one or more suspension members 16, such as ropes or belts. The one or more suspension members 16 interact with one or more sheaves 18 to be routed around various components of the elevator system 10. The one or more sheaves 18 could also be connected to a counterweight 22, which is used to help balance the elevator system 10 and reduce the difference in suspension member 16 tension on both sides of a traction sheave 24 during operation.

The elevator system 10 further includes one or more guide rails 28 to guide the elevator car 12 along the hoistway 14. The elevator car 12 includes one or more guide shoes or rollers (not shown) interactive with the guide rails 28 to guide the elevator car 12. The elevator car 12 also may include safeties (not shown) interactive with the guide rail 28 to slow and/or stop motion of the elevator car 12 under certain conditions, such as an overspeed condition.

The hoistway 14 includes one or more landing floors 34 at which the elevator car 12 stops to allow ingress and/or egress of passengers from the elevator car 12 through elevator car doors (not shown). A landing floor door 36 is located at each landing floor 34 of the hoistway 14. During elevator system operation, the landing floor door 36 opens when the elevator car 12 is present at the landing floor 34 to allow for passenger ingress and/or egress.

Many parameters of the elevator system 10 are set at system installation and then measured at intervals during the life of the elevator system 10, and may be adjusted if needed, by service personnel. One such parameter is runby 38, a clearance between elevator system components at the bottom of the hoistway 14. In some embodiments, the runby 38 is measured between a bottom of the counterweight 22 and a buffer 40 fixed at a bottom of the hoistway 14. In an alternative embodiment, the buffer 40 is fixed to the elevator car 12, and the runby 38 is measured between the buffer 40 and the bottom of the hoistway 14. Runby 38 is determined with the elevator car 12 in its uppermost position in the hoistway 14. Thus, the counterweight 22 is at its lowermost position in the hoistway 14. In some embodiments, the runby 38 is set to about 50 mm at installation of the elevator system 10.

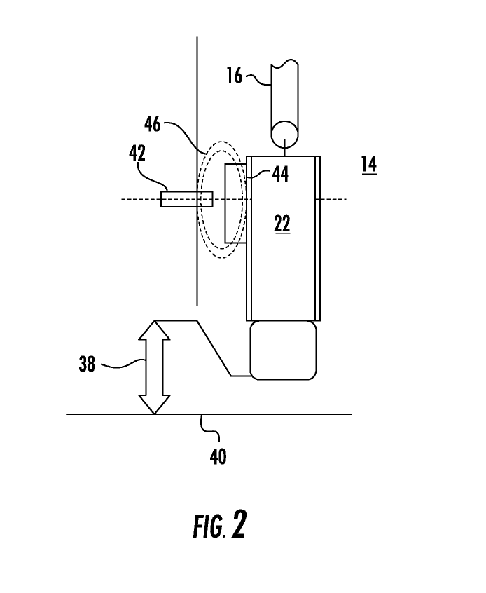

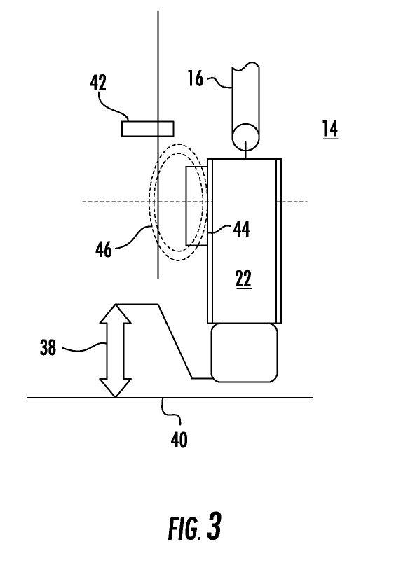

The runby 38 is monitored over time by a runby sensor located in the hoistway 14. In some embodiments, the runby sensor is a magnetic switch 42. It is to be appreciated, however, that in other embodiments, other types of runby sensors, for example optical sensors or mechanical sensors, may be utilized. Referring to FIG. 2, the magnetic switch 42 is fixed in the hoistway 14, for example, secured to a hoistway wall and is interactive with a magnet 44 or other sensed element located on the counterweight 22 such that when aligned in the hoistway 14, a magnetic field 46 of the magnet 44 is detected by the magnetic switch 42. The magnetic switch 42 and the magnet 44 are installed such that the magnet 44 aligns with the magnetic switch 42 when the runby 38 is at selected value, for example, 50 millimeters. As shown in FIG. 3, when the runby 38 is outside of a preselected range, such as about 30-70 millimeters, the magnetic switch 42 will no longer detect the magnetic field 46 of the magnet 44.

Referring again to FIG. 1, in some embodiments, the magnetic switch 42 is connected to an elevator control system 48, which constantly monitors the runby 38. Each time the elevator car 12 is driven to its uppermost position in the hoistway 14, the elevator control system 48 checks that the magnetic switch 42 detects the magnet 44. If the magnet 44 is detected, the runby 38 is acceptable, and if the magnet 44 is not detected, the runby 38 is flagged as not acceptable. In some embodiments, the elevator control system 48 may be linked to a remote elevator monitoring (R.E.M.) system 50, which monitors operating conditions and/or maintenance or service needs of the elevator system 10. In the event the magnetic switch 42 does not detect the magnet 44, this condition is forwarded to the remote elevator monitoring system 50 to initiate a maintenance call for the runby 38 to be adjusted.

When the runby 38 needs adjusting, the service technician rides the elevator car 12 to the top of the hoistway 14. At the top of the hoistway 14, the service technician can access a runby adjustment mechanism 52, in some embodiments, one or more screws, at a suspension member termination 54 in the hoistway 14. Access is provided via a service panel 56 in the elevator car 12. The service panel 56 is a door closed during normal operation of the elevator system 10, but which may be opened during service operations allowing the service technician to adjust the runby 38 from inside of the elevator car 12. The service technician operates the runby adjustment mechanism 52, effectively raising or lowering the counterweight 22 in the hoistway 14 until the magnetic switch 42 again detects the magnet 44.

In some embodiments, the system may include feedback for the service technician during adjustment of the runby 38. For example, an indicator light 58 may be located at, for example, the service panel 56 in particular at an inside of the service panel 56 such that the indicator light 58 is out of view of passengers during normal operation of the elevator car 12. The indicator light 58 is linked to the magnetic switch 42 through, for example, the elevator control system 48 or the remote elevator monitoring system 50. During adjustment of the runby 38, the indicator light 58 may initially indicate that the magnetic switch 42 does not detect the magnet 44 and that the runby 38 is in need of adjustment by illuminating, for example, a red color. As the runby 38 is adjusted, the counterweight 22 will reach a position where the magnetic switch 42 detects the magnet 44 and the light 58 may then illuminate in a green color. It is to be appreciated that the indicator light 58 and the red and green colors are merely exemplary, and that other types of feedback to the service technician, for example, audible alarms, or other visual indicators may be utilized.

The runby 38 monitoring system, including the magnetic switch 42 and the links to the elevator control system 48 and remote elevator monitoring system 50 provide a service-friendly solution that enables checking of runby 38 without the need for a service technician to enter the hoistway 14. Further, monitoring can be done continuously, in contrast to just a periodic measurement being performed. Further the present disclosure enables adjustment of the runby 38 when needed from inside of the elevator car 12, without the need for the service technician to enter the hoistway to perform the adjustment. Additionally, the indicators provide feedback during adjustment of the runby 38, so that repeated measurements of the runby 38 by the service technician during adjustment are unnecessary. Further, the disclosed system allows for checking and adjustment of the runby 38 from entirely inside of the elevator car 12.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate in spirit and/or scope. Additionally, while various embodiments have been described, it is to be understood that aspects of the present disclosure may include only some of the described embodiments. Accordingly, the present disclosure is not to be seen as limited by the foregoing description, but is only limited by the scope of the appended claims.

1. A runby monitoring system for an elevator system comprising:
a sensor fixed in a hoistway of the elevator system; and
a sensed element located at a moving component of the elevator system, the sensor configured to detect a presence of the sensed element when the sensed element is substantially aligned with the sensor in the hoistway;
wherein the detection of the presence of the sensed element at an expected elevator system operational point is indicative of a clearance between the moving component of the elevator system and a lowermost extent of the hoistway within a preselected range.

2. The runby monitoring system of claim 1, wherein lack of detection of the presence of the sensed element at the expected elevator system operational point is indicative of the clearance outside of the preselected range.

3. The runby monitoring system of claim 1, further comprising an elevator control system operably connected to the sensor to monitor the detection of the sensed element by the sensor.

4. The runby monitoring system of claim 1, further comprising a remote elevator monitoring system to initiate a maintenance action in the case of a lack of detection of the presence of the sensed element at the expected elevator system operational point.

5. The runby monitoring system of claim 1, wherein the sensor is a magnetic switch affixed at the hoistway and the sensed element is a magnet affixed to the moving component.

6. The runby monitoring system of claim 1, wherein the moving component is an elevator system counterweight.

7. An elevator system, comprising:
a hoistway;
an elevator car drivable along the hoistway;
a suspension member disposed in the hoistway and operably connected to the elevator car to suspend and/or drive the elevator car along the hoistway;
a counterweight operably connected to the suspension member to balance operation of the elevator system; and
a runby monitoring system including:
a sensor fixed in the hoistway; and
a sensed element located at a moving component of the elevator system, the sensor configured to detect a presence of the sensed element when the sensed element is substantially aligned with the sensor in the hoistway;
wherein the detection of the presence of the sensed element at an expected elevator system operational point is indicative of a clearance between the moving component and a lowermost extent of the hoistway within a preselected range.

8. The elevator system of claim 7, wherein lack of detection of the presence of the sensed element at the expected elevator system operational point is indicative of the clearance outside of the preselected range.

9. The elevator system of claim 7, further comprising an elevator control system operably connected to the sensor to continuously monitor the detection of the sensed element by the sensor.

10. The elevator system of claim 7, further comprising an elevator car service panel disposed at the elevator car to allow for adjustment of the clearance without exiting the elevator car.

11. The elevator system of claim 10, further comprising an indicator disposed at the elevator car service panel operably connected to the sensor to provide indication of detection and/or lack of detection of the sensed element by the sensor.

12. The elevator system of claim 7, wherein the elevator car is disposed at an uppermost position in the hoistway at the expected elevator system operational point.

13. The elevator system of claim 7, wherein the moving component is the counterweight.

14. A method of operating an elevator system, comprising:
driving an elevator car to an uppermost extent of a hoistway; and
checking for the presence of a moving component of the elevator system at an expected hoistway location via:
a sensor fixed at the hoistway; and
a sensed element secured to the moving component, the sensor configured to detect a presence of the sensed element when the sensed element is substantially aligned with the sensor in the hoistway;
wherein the detection of the presence of the sensed element is indicative of a clearance between the moving component and a lowermost extent of the hoistway within a preselected range.

15. The method of claim 14, further comprising adjusting the clearance between the moving component and the lowermost extent of the hoistway if the presence of the sensed element is not detected by the sensor.

16. The method of claim 15, further comprising adjusting the clearance by:
accessing a runby adjusting mechanism through an elevator car service panel of the elevator car; and
operating the runby adjusting mechanism until the sensor detects the presence of the sense element.
